(19) United States
(12) Patent Application Publication
(10) Pub. No.: US 2024/0336072 A1
(43) Pub. Date: Oct. 10, 2024

(54) METHOD AND APPARATUS FOR PRINTING ON IRREGULAR CONTAINERS

(71) Applicant: Dekron GmbH, Kelkheim (DE)

(72) Inventors: Thomas Spellucci, Eschborn (DE); Klaus Eich, Hofheim (DE); Frank Ufer, Idstein (DE)

(21) Appl. No.: 18/626,122

(22) Filed: Apr. 3, 2024

(30) Foreign Application Priority Data
Apr. 6, 2023 (DE) 102023108931.5

(51) Int. Cl. B41J 2/21; B41J 3/407; B41M 5/00; G06K 15/02

(52) U.S. Cl. CPC B41J 2/2132; B41J 3/40733; B41M 5/0088; G06K 15/027; G06K 2215/101

(57) ABSTRACT

A direct printing method for printing on an irregular container, wherein a pixel offset is determined for a pixel of a printing original for a printed image based on a target diameter and an actual diameter of the container to be printed on, wherein a corrected printing original is generated based on the determined pixel offset, wherein, based on the corrected printing original, the print image is applied to the irregular container by means of a direct printing apparatus having a plurality of printing nozzles.

### CROSS-REFERENCE TO RELATED APPLICATION(S) AND CLAIM OF PRIORITY

This application claims priority to German Patent Application No. 102023108931.5, filed Apr. 6, 2023, the disclosure of which is incorporated herein by reference in its entirety.

### TECHNICAL FIELD

The present invention relates to a method for printing on irregular containers, and to an apparatus for printing irregular containers.

### BACKGROUND

Methods and apparatuses for printing on irregular containers are known from the prior art.

In order to avoid distortions of a printed image applied to an irregular container surface, it is known, for example, to control the ejection timing of ink droplets from the printing nozzles of a direct printing apparatus based on a shape of a container.

DE 10 2017 215 429 A1 also discloses a direct printing method for a direct printing machine for printing containers, in particular molded containers, with a direct printing. In detail, a printing movement path of the direct printing machine is created from 3D data of the containers, and a 3D printing model is created from printing parameters of the direct printing machine in order to predict an image of a printing graphic original to be printed on the containers as a direct print. A macroscopic correction and a microscopic correction are determined by means of the 3D printing model, wherein the macroscopic correction comprises an inverse of a distortion of the printing graphic original on the containers, and the microscopic correction comprises a nozzle correction. Subsequently, the printing graphic original is corrected with the macroscopic correction and stored in a corrected printing graphic, wherein a printing raster image is generated from the corrected printing graphic by using a raster image processor. The printing raster image is then corrected on the basis of the microscopic correction and stored as a corrected printing raster image and is printed onto the containers by the direct printing machine as the direct print.

This method allows the actual curved shape of the container to be taken into account.

However, the print images created in this way are only partially sufficient in terms of quality and resolution in some regions of the container.

### SUMMARY

Based on the known prior art, the technical object to be achieved is to specify a flexible, applicable direct printing method with which the surface of irregular containers can be provided with high-quality print layers.

This object is achieved according to the invention by the method for printing on containers and the apparatus for printing on containers. Preferred further developments of the invention are also disclosed.

The direct printing method according to the invention for printing on an irregular container comprises determining a pixel offset for a pixel of a printing original for a printed image based on a target diameter and an actual diameter of the container to be printed on, generating a corrected printing original based on the determined pixel offset, and applying the printed image onto the irregular container based on the corrected print template by means of a direct printing apparatus having a plurality of printing nozzles.

This method can be used to print on different types of containers, preferably bottles made of glass, plastic or material containing fibers used in the beverage industry. However, the method is not limited to the type of containers just mentioned and can also be used, for example, to print on cups, glasses, cans or tubes, such as those used in the beverage, pharmaceutical, healthcare or food industries, or any other container that is suitable for holding a liquid or pasty medium.

An irregular container is to be understood as a container whose surface deviates from an ideal cylindrical shape. For example, a container whose container surface is at least partially conical in shape can be understood as an irregular container. This includes, for example, a container which has a cylindrical base body and a conical shoulder region. Containers whose container surface is at least partially round or conical in shape can also be considered irregular containers. Furthermore, containers which, for example, comprise a depression in the container surface in the form of an embossing or a raised region on the container surface in the form of a debossing can also be classified as irregular containers.

The target diameter is to be understood as the largest diameter of the container along its container longitudinal axis. The actual diameter is understood to mean the diameter of the container at the position of the surface at which the pixel of the printing original is to be applied by the direct printing apparatus. When the term diameter is used in the following, it refers to the outside diameter of the container.

The printing original is preferably a raster graphic of the printed image. If the printed image is available as a vector-based graphic, it may be necessary, for example, to convert the vector-based graphic into a raster graphic in order to obtain a printing original with which the method according to the invention can be carried out.

A pixel offset is understood to mean a relative displacement of a pixel coordinate P of the printing original to a new coordinate P+ΔP in the corrected printing original in relation to the (original) printing original. Preferably, the relative displacement is a displacement parallel to the direction along which the printed image is applied to the circumference of the container.

With the method according to the invention, a corrected printing original can be generated based on the actual diameter and the target diameter of the container, by means of which a distortion of a printed image applied to the container surface caused by the irregular shape of the container without the correction can be compensated. Since the corrected printing original can be used with any printing apparatus suitable for direct printing on containers, the method according to the invention allows flexible printing on irregular containers without the direct printing apparatus for printing on the containers having to meet special requirements or existing apparatuses having to be converted.

In one embodiment, determining the pixel offset comprises determining a first pixel offset term for correcting a time of flight of an ink droplet ejected by a printing nozzle. The time of flight is to be understood here as the time required by an ink droplet from the time of ejection from the printing nozzle until it strikes the container surface, assuming a constant flight speed. In this case, the time of flight depends on the distance between the printing nozzle opening and a position on the container surface on which the ink droplet ejected from the printing nozzle opening strikes, and the ejection speed of the ink droplet. Consequently, the flight time of an ink droplet until it strikes the position on the container surface whose actual diameter is smaller than the target diameter of the container is longer than the flight time until the ink droplet strikes a position on the container surface whose diameter corresponds to the target diameter. With regard to positions on the container surface whose actual diameter is smaller than the target diameter, this leads to an undesired displacement of the point of impact of an ink droplet on the container surface in the printing direction (for example, due to a deflection of the ink droplet due to the acting force of gravity and/or the airflow due to the movement of the container or the like), which in turn results in a distortion of the printed image and a printing graphic of inferior quality. The correction of the pixel offset caused by the time of flight thus minimizes distortion effects of the printed image and leads to an increase in the quality of the print result.

In a further embodiment of this embodiment, the first pixel offset term is determined based on a target surface speed of the container, a flight speed of the ink droplet, and a pixel density of the printed image. The target surface speed is a surface speed of a position of the container surface, the diameter of which corresponds to the target diameter of the container. Pixel density is to be understood as a number of pixels per inch of the printed image (can be specified one-dimensionally as a linear pixel density along a specific direction or also two-dimensionally as surface pixel density along the surface of the container), which is to be applied to the container surface by the direct printing apparatus. In addition to the actual diameter and the target diameter, the parameters described in connection with this embodiment allow an accurate determination of the pixel offset caused by the dependence on distance of the time of flight of an ink droplet and therefore a precise correction of the distance-dependent time of flight of an ink droplet from the time it exits the printing nozzle opening until it strikes the container surface position.

In one embodiment, determining the pixel offset comprises determining a second pixel offset term for correcting a change in flight speed of an ink droplet ejected by a printing nozzle. In addition to the effect described above, as the actual diameter decreases and the distance between the printing nozzle opening and the container surface element increases, air friction effects lead to a decrease in the ink droplet flight speed. This effect causes a further displacement of the point of impact of an ink droplet in the printing direction, which increases as the actual diameter decreases. The same applies to an actual diameter which is larger than the target diameter of the container. By correcting a pixel offset caused by the change in the flight speed, distortion effects of the printed image can therefore be further minimized, and the quality of the printed image can be further improved.

In a further embodiment of this embodiment, the second pixel offset term is determined based on a pixel density, a target surface speed of the container, a flight speed of the ink droplet when exiting a printing nozzle, and an average speed of the ink droplet. The average speed is an average value of the speed of the ink droplet when exiting the printing nozzle opening and the speed of the ink droplet when striking the container surface. In addition to the actual diameter and the target diameter, these parameters allow a precise determination of the pixel offset caused by the change in flight speed, and a precise correction of this pixel offset.

In one embodiment, determining the pixel offset comprises determining a third pixel offset term for correcting a composition-dependent flight behavior of an ink droplet ejected by a printing nozzle. Composition is understood to mean a chemical or color composition of the ink droplet. Since the chemical or color composition of an ink droplet has a direct influence on its flight behavior (for example, due to the viscosity of the ink droplet and/or of the friction resistance acting on the surface), this also leads to a shift in the point of impact of the ink droplet in the printing direction, which is characteristic of the printing ink used, and thus to an undesirable distortion of the printed image. By correcting a pixel offset caused by the composition of the ink droplet, distortion effects of the printed image can be further minimized, and the quality of the printed image can be further improved.

In a further development of this embodiment, the third pixel offset term is determined based on a relative composition-dependent correction factor and a ratio of the target diameter and a minimum diameter of the container. The relative correction factor describes a relative correction for a specific printing ink composition in relation to a standard ink. The minimum diameter of the container in turn corresponds to the minimum diameter of the container in a print region. By means of the parameters described above, the pixel offset caused by the ink composition can be precisely determined, and the distortion of the printed image caused by this effect can be corrected.

In one embodiment, the printing nozzles of the direct printing apparatus are arranged in at least two adjacent rows of printing nozzles in the printing direction, and the determination of the pixel offset comprises a determination of a fourth pixel offset term to correct for a direct printing apparatus having at least two adjacent rows of printing nozzles. In particular, the two rows of printing nozzles can be offset from each other by half the distance between two immediately adjacent printing nozzles of a row of printing nozzles along the printing nozzle direction. The fourth correction term can be used to ensure that the ink droplets ejected by the rows of print nozzles are applied one below the other to the surface of the container in exactly one row, preventing distortion of the printed image on the irregular container and increasing the quality of the print layer.

In a further development of this embodiment, the fourth pixel offset term is determined to correct a pixel offset of the row of nozzles trailing in relation to the printing direction based on a distance between the two rows of printing nozzles. This makes it possible to determine the correction factor for the printing nozzle trailing in relation to the print feed, and to achieve a higher-resolution printed image even on irregular containers.

In one embodiment, the printing original is divided into different color layers before determining the pixel offset, and the pixel offset is determined separately for each color layer. Thus, not only can a correction be carried out when using a printing ink, but a correction can also be carried out when using color printing.

In one embodiment, a corrected printing original is determined for each color layer based on the determined pixel offsets. Thus, colored printed images can also be applied to irregular containers, wherein an individual corrected print template is provided separately for each color layer, and thus a distortion-free application for each of the color layers can be ensured even on irregular containers.

A direct printing apparatus for printing on irregular containers is also according to the invention, wherein the direct printing apparatus comprises a printing module with a plurality of printing nozzles and a control unit, wherein the control unit is designed to carry out the method according to one of the preceding embodiments.

The control unit can thus generate a corrected printing original based on the actual diameter and the target diameter of the container, which can be used to compensate for distortions of a printed image applied to the container surface caused by the irregular shape of the container. Since the corrected printing original can be used with any printing apparatus suitable for direct printing on containers, the method according to the invention allows flexible printing on irregular containers without the direct printing apparatus having to fulfill any further requirements.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates apparatuses for printing on an irregular container according to one embodiment; and

FIG. 2 illustrates a schematic representation of a direct printing apparatus for printing on an irregular container according to a further embodiment.

### DETAILED DESCRIPTION

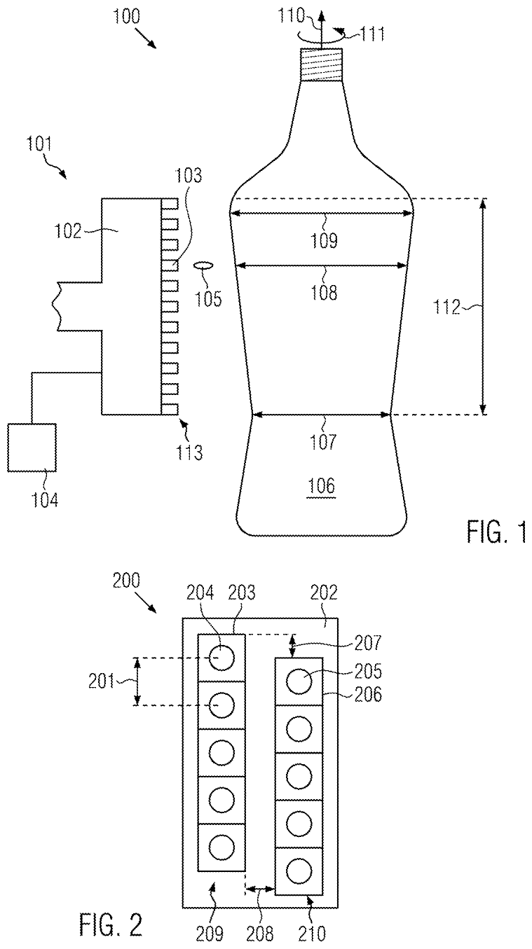

FIGS. 1 and 2, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged method and apparatus for printing on irregular containers.

FIG. 1 shows an apparatus 100 for carrying out the method according to the invention for printing on an irregular container 106 according to one embodiment. An irregularly shaped container can be understood, for example, as a container that has a basic shape (e.g. cylindrical or cubic), but whose surface deviates from this basic shape at least in certain regions (e.g. through embossing, debossing, curvatures of the surface that deviate from the basic shape, for example in the neck region of the container or similar).

Shown is a direct printing apparatus 101 comprising a printing module 102 having a plurality of printing nozzles 103 for ejecting ink droplets 105 onto the surface of the irregular container 106. In the embodiment discussed herein, the printing nozzles are arranged in a printing nozzle row 113. The number of printing nozzles 103 and their arrangement is to be understood as exemplary. A printing module 102 having any other number of printing nozzles may also be provided. For this purpose, the printing module 102 is arranged next to the container to be printed, so that when the container is rotated about its longitudinal axis 110, a printed image can be applied in a print region 112 along the circumference thereof.

The container 106 is preferably a bottle used in the beverage processing industry made of glass, plastic or material comprising fibers. However, the container is not limited to this design and can alternatively or additionally be designed as a cup, a glass, a can or a tube, such as those used in the beverage, pharmaceutical, healthcare or food industries, or as any other type of container suitable for holding a liquid or pasty medium.

In the following, without limiting the generality, the container is described as an irregular container having a substantially cylindrical basic shape or ideal cylindrical shape as basic shape, the surface of which deviates from an ideal cylindrical shape. For example, a container whose container surface is at least partially conical in shape can be understood as an irregular container. Containers whose surface is at least partially spherical or conical in shape are also to be understood as irregular containers. The surface of the irregular container shown in FIG. 1 tapers along the container longitudinal axis 110 towards the center of the container and has a maximum diameter (target diameter) D_{target} 109 in the shoulder region.

However, the apparatus 100 described in FIG. 1 is not limited to printing on this specific container shape and is suitable for printing on any irregular container, as already explained above.

In order to achieve a rotation 111 of the container 106 about its longitudinal axis 110, the container can, for example, be placed on a rotary plate which can be caused to rotate by means of an output drive, for example a servomotor (not shown here). Preferably, the drive of the rotary plate and the direct printing apparatus 101 are synchronized with one another, so that the rotational speed of the rotary plate or the container 106 is matched to a printing speed of the direct printing apparatus 101.

In one embodiment, it may be provided that the rotary plate is designed as a container receptacle of a rotary machine of a container treatment system, and the direct printing apparatus 101 is arranged stationary along the periphery of the rotary machine. Alternatively, the direct printing apparatus 101 can also be associated directly with the container receptacle or the rotary plate. In a further embodiment, it may also be provided that the printing module 102 of the direct printing apparatus 101 is rotatably mounted about the container longitudinal axis 110 and is moved around the circumference of the container 106 for applying the printed image to the container surface.

The direct printing apparatus 101 may be configured to print different types of colors, such as white color, CMYK colors, varnish colors, and special colors. The colors are preferably UV printing inks, although other types of printing inks can also be used as an alternative. In one embodiment, a plurality of printing modules can be arranged one behind the other along the container circumference, for example in the direction of rotation of the container, wherein a different color is applied to the container surface by each of the printing modules. The direct printing apparatus can also be configured to print functional inks, such as conductive, temperature-sensitive or magnetic inks. The direct printing apparatus may optionally comprise a curing unit with a light source for emitting UV radiation. Other types of light sources, such as a light source operating in the visible wavelength range, are also conceivable. In particular, the light source can be selected based on the ink printed by the direct printing apparatus.

According to the invention, the direct printing apparatus 101 comprises a control unit 104 (for example a computer with a processor and associated volatile or non-volatile memory) which is designed to control the printing nozzles 103 of the direct printing device 101 based on a printing original and thus to cause an application of printing ink in order to generate a printed image on the surface of the irregular container 106. According to the invention, the control unit 104 is also configured to determine a pixel offset for at least one pixel of a printing original based on an actual diameter 108 and a target diameter 109 of the container 106 to be printed on, and to generate a corrected printing original based on the determined pixel offset, as will be described below.

The target diameter 109 is understood to be the maximum diameter of the container, whereas the actual diameter 108 describes the diameter of the container 106 at a surface position at which the pixel of the printing original is to be applied by the direct printing apparatus. The diameter is generally understood to be the outer diameter of the container, as the outer surface of the container is printed.

The printing original can be, for example, a raster graphic of the printed image that is to be applied to the surface of the container. If the printed image is available as a vector graphic, for example, one embodiment may provide for the vector graphic to be converted into a raster graphic. The printing original can be in a JPEG, a PNG, a GIF, a BMP or a TIFF format, for example. However, any other image format suitable for displaying a raster graphic can also be used.

The pixel offset describes a relative displacement ΔP of a pixel coordinate P of the printing original, wherein by means of the pixel offset, a difference between the actual diameter of the container at the surface position at which the corresponding pixel coordinate of the printing original is to be applied and a resulting distortion of the printed image can be compensated. Preferably, the relative displacement is a displacement parallel to the direction along which the printed image is applied to the circumference of the container 106.

In one embodiment, the control unit 104 may comprise a memory unit in which the printing original is stored. In addition, surface data of the container to be printed on can be stored in the memory unit. The surface data can, for example, comprise a plurality of surface coordinates of the container, wherein each surface coordinate of the container is associated with an actual diameter of the container at the corresponding surface coordinate. In the case of rotationally symmetrical containers, it may be sufficient if the surface data comprise a plurality of height positions of the container along its longitudinal axis and the actual diameter of the container associated with each of the height positions. Alternatively, a function can also be stored in the memory unit which describes the container diameter as a function of a height position along the container longitudinal axis.

In addition to the surface data, further method parameters used to determine the pixel offset can be stored in the memory unit. For example, the target diameter of the container, which describes the maximum diameter of the container and is preferably used to carry out the method according to the invention, can also be stored in the memory unit. Optionally, a print region, which describes a surface area of the container to which the printed image is to be applied, can also be stored in the memory unit. For example, the print region can be described by at least one surface coordinate of the container. Alternatively, the print region can also be described by two height positions along the container longitudinal axis 110 and an angle of rotation of the container.

The surface data and the further method parameters can be stored for a plurality of different container types in a database of the memory unit, so that the apparatus described in FIG. 1 can be used flexibly and can print on different container types. Alternatively, it may also be provided that the control unit 104 is connected to a server comprising a database with various data sets of surface data, method parameters, printing originals, and printed images. The control unit 104 may be connected to an input unit so that a user can select a specific type of container before carrying out the method. In one embodiment, it may also be provided that the direct printing apparatus comprises a recognition unit, such as a camera, by means of which a container can be automatically recognized and certain data, such as the surface data or the method parameters, are automatically loaded from the database by the control unit 104.

The control unit 104 can then determine a pixel offset for at least one pixel of the printing original based on the actual diameter 108 of the container at the position at which the pixel is to be applied and the target diameter 108. The actual diameter D_{actual} 108 can be determined by the control unit 104, for example, based on the container surface data described above. In the corrected printing original, the at least one pixel is then displaced by the determined pixel offset with respect to the printing direction, so that a difference between the actual diameter and the target diameter and the resulting offset of the point of impact of the ink droplet 105 can be compensated for. As the pixel offset is proportional to the difference D_{actual}−D_{target}, and D_{actual}≤D_{target} applies, the displacement of the corresponding pixel in the corrected print template takes place counter to the printing direction. As a result, the corresponding pixel of the corrected printing original is printed at an effectively earlier point in time by the corresponding printing nozzle, or the corresponding ink droplet 105 is ejected at an earlier point in time than the corresponding pixel of the original printing original. By displacing the pixel counter the printing direction, a deviation of the actual diameter from the target diameter at the corresponding container surface position can therefore be effectively compensated for, and a distortion of the applied printed image can be prevented.

The pixel offset determined for correcting the printing original may comprise one or a plurality (in particular a sum) of pixel offset terms, each of which, for example, determines a pixel offset attributable to a particular cause (as described below) and corrects the printing original based thereon. It is understood that the correction of the printing original can be carried out based on at least one or any combination of the individual pixel offset terms, even if the pixel offset terms are described in isolation from one another below.

In one embodiment, it may be provided that the pixel offset comprises a first pixel offset term for correcting a time of flight of an ink droplet 105 ejected by a printing nozzle 103 until it strikes the container surface. As the actual diameter D_{actual} 108 of the container decreases, the distance between a printing nozzle opening 103 of the direct printing module from which the ink droplet is ejected and the container surface position to which the ink droplet 105 is applied increases. However, as the distance increases, the time of flight of the ink droplet also increases, so that the ink droplet strikes the container surface at a later point in time and therefore offset in the printing direction in comparison to a container surface position with the target diameter D_{target} 109. The greater the deviation of the actual diameter 108 from the target diameter 109 of the container at the point at which the ink droplet 105 is to be applied, the greater the offset of the ink droplet 105 when it strikes the container surface in the printing direction, and the stronger the distortion of the printed image generated compared to the original printing original. The same applies in the event that the diameter D_{actual} is greater than the diameter D_{target}.

In addition to the actual 108 and the target diameter 109, the target surface speed v_{target} of a position of a container surface with maximum container diameter D_{target}, the flight speed of the ink droplet vᵢₙₖ and the pixel density dpi of the printed image to be applied in units of print dots per inch can be used to determine the pixel offset caused by the effect just described. These parameters can also be stored in the memory unit of the control unit 104, so that the control unit can access them to determine the pixel offset.

For the first pixel offset term, the following can apply:

$$Δ {P}_{1} = \frac{dpi}{25.4} \frac{{v}_{target}}{{v}_{ink}} \cdot \frac{1}{2} ( {D}_{actual} - {D}_{target} ) .$$

Based on this context, the control unit 104 can then determine a first pixel offset term for at least one pixel of the printing original, whereby a pixel offset caused by the distance dependence of the time of flight of an ink droplet 105 can be taken into account, and a corrected printing original can be created. Thus, for the position of a corrected pixel of the corrected printing original, P′=P+ΔP₁ applies, where P describes the position of the corresponding pixel in the original printing original. As already described above, ΔP₁≤0, so that the displacement here also takes place counter the printing direction. If the printing apparatus is now used to apply a printed image to the container surface based on the corrected printing original, the distortion effects in the printed image caused by the time-of-flight difference can be compensated for and the quality of the printed image produced can be improved.

In a further embodiment, it may be provided that determining the pixel offset comprises determining a second pixel offset term for correcting a change in flight speed of an ink droplet ejected by a printing nozzle. While a constant speed of the ink droplet 105 is assumed for the change in flight time determined in connection with the preceding embodiment, the difference between the actual diameter 108 at the position of the container surface on which the ink droplet 105 is to be applied and the target diameter 109 also leads to a change in the flight speed of the ink droplet 105. In particular, air friction effects are responsible for this, which lead to a reduction of the flight speed of the ink droplet 105 as the actual diameter 108 decreases, and a corresponding displacement of the point of impact of the ink droplet 105 in the printing direction.

To correct for this effect, a second pixel offset term can be determined by the control unit 104, which, in addition to the actual diameter 108 of the container at the surface position at which the pixel is to be applied and the target diameter 109, also determines the flight speed of the ink droplet 105 as it exits the printing nozzle opening v_{ink norm}, the mean ink speed v_{ink mean}=½ (v_{ink norm}+v_{ink min}) and the difference between the actual diameter and the target diameter A_{diff}=(D_{actual}−D_{target}). v_{ink min} describes the flying speed of the ink droplet 105 when it strikes the container surface and is calculated using the relationship v_{ink min}=v_{ink norm}(1−v_{delta})^{A}^{_{diff}}, where v_{delta} describes the decrease in speed of the ink droplet per distance (e.g. per mm of flying distance). These parameters can also be stored in the memory unit of the control unit 104, so that the control unit 104 can access them to determine the second pixel offset term.

The second pixel offset term can then be determined as

$$Δ {P}_{2} = \frac{dpi}{25.4} {v}_{target} ( \frac{{A}_{diff}}{{v}_{ink norm}} - \frac{{A}_{diff}}{{v}_{ink mean}} ) .$$

Based on this context, the control unit 104 can then determine a second pixel offset term for at least one pixel of the printing original, so that a pixel offset caused by the change in the flight speed of the ink droplet 105 can be taken into account, and a corrected printing original can be generated. If a printed image is now applied to the container surface using the printing apparatus 101 based on the corrected printing original, then the distortion effects in the printed image caused by the change in flight speed can be compensated for, and the quality of the printed image generated can be further improved.

In a further embodiment, it may be provided that determining the pixel offset comprises determining a third pixel offset term for correcting a composition-dependent flight behavior of an ink droplet 105 ejected by a printing nozzle 103. In particular, a composition is to be understood as a chemical or a color composition of the ink droplet 105. In particular, the composition of the ink droplet has an influence on its viscosity, so that ink droplets of different compositions, due to air friction, are deformed to different degrees during their flight from the printing nozzle opening 103 until they strike the container surface, and thus exhibit different flight behavior. The different flight behavior in turn leads to an undesired offset of the point of impact of ink droplets 105 of a different composition on the container surface.

In addition to the actual diameter and the target diameter, the third pixel offset term is determined based on a relative correction factor Kᵣₑₗ, which depends on the composition of the ink droplet. In one embodiment, the relative correction factor can be calculated using the quotient of a relative offset Oᵣₑₗ and the ratio of the minimum diameter of the container in the print region Dₘᵢₙ 107 and the target diameter D_{target} 109 as

$${K}_{rel} = \frac{{O}_{rel}}{\frac{{D}_{m i n}}{{D}_{target}}} .$$

These parameters can also be stored in the memory unit of the control unit 104, so that the control unit can access them to determine the third pixel offset term.

Accordingly, the third pixel offset term can then be determined as

$$Δ {P}_{3} = \frac{1}{2} ( {D}_{actual} - {D}_{target} ) {K}_{rel} .$$

Analogous to the procedure described in connection with the first and second pixel correction terms, the control unit 104 can then determine a pixel offset caused by the composition of the ink droplet 105 based on the third pixel offset term for at least one pixel of the printing original, and generate a corrected printing original therefrom. If a print image is now applied to the container surface using the printing apparatus 101 based on the corrected printing original, then the distorted effects in the print image caused by the composition of the ink droplet 105 can be compensated for, and the quality of the printed image generated can be further improved.

All embodiments described above can be combined with one another. For example, it may also be provided to determine a pixel offset for at least one pixel of the printing original, which pixel offset comprises a first, second and third pixel offset term. Alternatively, it is also provided to determine a pixel offset based on the sum of the first and second pixel offset term, the sum of the first and third pixel offset term, or the sum of the second and third pixel offset term.

In a further embodiment, it may be provided to divide the print graphic into individual color layers before carrying out the method described above, and to apply the method according to one of the embodiments described above or a combination thereof to each of the color layers so that a corrected printing original (also called color layer printing original) is generated for each of the color layers. To apply the colored print image, a plurality of the printing apparatuses 101 shown in connection with FIG. 1 may then be arranged in series along the circumference of the container 106 and, by means of each of the printing apparatuses 101, a color printed image may be applied on the container surface based on one of the corrected color layer printing originals.

A more specific embodiment of the method described in connection with FIG. 1, in which the printing module 102 comprises two adjacent rows of printing nozzles, is described in connection with FIG. 2, wherein a plan view of the printing module 202 of a direct printing apparatus 200 according to one embodiment is shown.

In the embodiment described here, the printing nozzles 204, 205 of a printing nozzle row 209, 210 are equidistantly spaced from one another in the printing nozzle direction and are arranged in printing nozzle regions 203, 206. Preferably, the two adjacent rows of printing nozzles 209, 210 are aligned parallel to one another and displaced towards one another along the printing nozzle direction by half 207 of the printing nozzle distance 201. The printing module 202 described in FIG. 2 is to be understood as exemplary in its design; in particular, the rows of printing nozzles 209, 210 may also comprise any larger or smaller number of printing nozzles 204, 205. Furthermore, printing modules 202 are also conceivable in which, for example, a plurality of pairs of adjacent rows of printing nozzles 209, 210 are arranged one behind the other (viewed, for example, in the direction of rotation of the container in front of the respective printing module). For example, in one embodiment, two or three pairs of adjacent rows of printing nozzles 209, 210 may also be arranged according to the embodiment of FIG. 2. This can be provided, for example, if different colors are to be applied to the container surface by the different pairs of printing nozzles.

For containers having a constant container diameter in the print region, it is known to control the two printing nozzle rows 209, 210 using a standard correction in such a way that the distance of the two printing nozzle rows 208 is compensated perpendicular to the printing nozzle direction, and the ink droplets ejected by the first 209 and the second printing nozzle row 210 are applied to the container surface one below the other along a print dot row running parallel to the printing nozzle rows. The standard correction can thus generate a print dot row on the container surface with a resolution that is twice as high as the print resolution that can be achieved by a single print nozzle row 209, 210.

For irregular containers whose container diameter is not constant in the print region, the standard correction described above is no longer valid. Thus, the changing actual diameter of the container in the print region leads to an offset of the ink droplets ejected onto the container surface by the row of printing nozzles 209 trailing the printing direction compared to the ink droplets ejected by the leading row of printing nozzles 210. Consequently, a fourth pixel offset term is necessary for irregular containers, for the trailing 209 of the two rows of printing nozzles. Like the pixel correction terms already described in connection with FIG. 1, this correction is also dependent on the actual diameter 108 of the container at the position at which the ink droplet is to be applied by the corresponding printing nozzle of the trailing printing nozzle row, and the target diameter 109 of the container, which may correspond to the maximum container diameter. To determine the fourth pixel offset term, the distance between the two printing nozzle rows 208 is also used in units of the printing nozzle distance A_{nozzle rows} 201.

Thus, the following results for a pixel offset term for the trailing of the two printing nozzle rows

$$Δ {P}_{4} = {A}_{nozzle rows} ( 1 - \frac{{D}_{actual}}{{D}_{target}} ) .$$

By means of the fourth pixel offset term, the distance between the two adjacent rows of printing nozzles 209, 210 can thus also be corrected for irregular containers using the printing module 202 described in connection with FIG. 2 in such a way that the ink droplets ejected by the two rows of printing nozzles strike on one another along a row on the container surface and a row of print dots is generated on the container surface which has twice the resolution compared to the resolution of one of the two rows of printing nozzles 209, 210 of the printing module 202. Thus, undesired distortion effects that are caused by the changing actual diameter 107 in the print region 112 can be prevented, and high-quality printed images having a high print resolution can be achieved.

The embodiment shown in FIG. 2 can be combined with any of the previously described embodiments.

Although the present disclosure has been described with various embodiments, various changes and modifications may be suggested to one skilled in the art. It is intended that the present disclosure encompass such changes and modifications as falling within the scope of the claims.

The present disclosure should not be read as implying that any particular element, step, or function is an essential element, step, or function that must be included in the scope of the claims. Moreover, the claims are not intended to invoke 35 U.S.C. § 112 (f) unless the exact words “means for” are followed by a participle.

What is claimed is:

1. A direct printing method for printing on an irregular container, the method comprising:
determining a pixel offset for a pixel of a printing original for a printed image based on a target diameter and an actual diameter of the irregular container to be printed on; wherein, based on the determined pixel offset,
generating a corrected printing original; and
based on the corrected printing original, applying the printed image to the irregular container using a direct printing apparatus having a plurality of printing nozzles.

2. The direct printing method of claim 1, wherein determining the pixel offset comprises determining a first pixel offset term for correcting a time of flight of an ink droplet ejected by a printing nozzle of the plurality of printing nozzles.

3. The direct printing method of claim 2, wherein the first pixel offset term is determined based on a target surface speed of the irregular container, a flight speed of the ink droplet, and a pixel density of the printed image.

4. The direct printing method of claim 2, wherein determining the pixel offset comprises determining a second pixel offset term for correcting a change in flight speed of an ink droplet ejected by a printing nozzle of the plurality of printing nozzles.

5. The direct printing method of claim 4, wherein the second pixel offset term is determined based on a pixel density, a target surface speed of the irregular container, a flight speed of the ink droplet when exiting a printing nozzle of the plurality of printing nozzles, and an average speed of the ink droplet.

6. The direct printing method of claim 4, wherein determining the pixel offset comprises determining a third pixel offset term for correcting a composition-dependent flight behavior of an ink droplet ejected by a printing nozzle of the plurality of printing nozzles.

7. The direct printing method of claim 6, wherein the third pixel offset term is determined based on a relative composition-dependent correction factor and a ratio of target diameter and a minimum diameter of the irregular container.

8. The direct printing method of claim 6, wherein the plurality of printing nozzles of the direct printing apparatus are arranged in at least two rows of printing nozzle rows adjacent to one another in the printing direction, and wherein determining the pixel offset comprises determining a fourth pixel offset term for correcting a direct printing apparatus having at least two adjacent printing nozzle rows.

9. The direct printing method of claim 8, wherein the fourth pixel offset term is determined based on a distance of the rows of printing nozzles.

10. The direct printing method of claim 1, wherein the printing original is divided into different color layers before determining the pixel offset, and the pixel offset is determined separately for each color layer.

11. The direct printing method of claim 10, wherein a corrected printing original is determined based on the determined pixel offsets for each color layer.

12. The direct printing method of claim 3, wherein determining the pixel offset comprises determining a second pixel offset term for correcting a change in flight speed of an ink droplet ejected by a printing nozzle of the plurality of printing nozzles.

13. The direct printing method of claim 12, wherein the second pixel offset term is determined based on a pixel density, a target surface speed of the irregular container, a flight speed of the ink droplet when exiting a printing nozzle of the plurality of printing nozzles, and an average speed of the ink droplet.

14. The direct printing method of claim 13, wherein determining the pixel offset comprises determining a third pixel offset term for correcting a composition-dependent flight behavior of an ink droplet ejected by a printing nozzle of the plurality of printing nozzles.

15. The direct printing method of claim 14, wherein the third pixel offset term is determined based on a relative composition-dependent correction factor and a ratio of target diameter and a minimum diameter of the irregular container.

16. The direct printing method of claim 15, wherein the plurality of printing nozzles of the direct printing apparatus are arranged in at least two rows of printing nozzle rows adjacent to one another in the printing direction, and wherein determining the pixel offset comprises determining a fourth pixel offset term for correcting a direct printing apparatus having at least two adjacent printing nozzle rows.

17. The direct printing method of claim 16, wherein the fourth pixel offset term is determined based on a distance of the rows of printing nozzles.

18. The direct printing method of claim 17, wherein the printing original is divided into different color layers before determining the pixel offset, and the pixel offset is determined separately for each color layer.

19. The direct printing method of claim 18, wherein a corrected printing original is determined based on the determined pixel offsets for each color layer.

20. A direct printing apparatus for printing on irregular containers, wherein the direct printing apparatus comprises a printing module having a plurality of printing nozzles and a control unit, wherein the control unit is designed to carry out the method of claim 1.
